(19) United States
(12) Patent Application Publication
(10) Pub. No.: US 2019/0027993 A1
(43) Pub. Date: Jan. 24, 2019

(54) LIGHT WEIGHT MOTOR HOUSING

(71) Applicant: Ford Global Technologies, LLC, Dearborn, MI (US)

(72) Inventors: Stuart C. Salter, White Lake, MI (US); Paul Kenneth Dellock, Northville, MI (US); Chester Stanislaus Walawender, Livonia, MI (US)

(21) Appl. No.: 15/652,427

(22) Filed: Jul. 18, 2017

(51) Int. Cl. H02K 5/02; H02K 1/17; H02K 1/02; H02K 5/16; H02K 7/116; H02K 15/14

(52) U.S. Cl. CPC H02K 5/02; H02K 1/17; H02K 15/14; H02K 5/16; H02K 7/1166; H02K 1/02

(57) ABSTRACT

An electric motor utilized in vehicle actuators is disclosed and includes an electrically conductive plastic housing defining an interior cavity and a plurality of magnetic plastic magnets supported within the interior cavity of the housing.

### TECHNICAL FIELD

This disclosure relates to an electric motor for window, seat and other accessory actuators used within a vehicle.

### BACKGROUND

Vehicle windows, seats and other devices are actuated by small permanent magnet electric motors. Permanent magnet electric motors include permanent magnets disposed within an electrically conductive metal housing. An armature rotor is disposed within the housing and rotates relative the permanent magnets. Fabrication of the metal housing typically requires many different process and machining steps. Moreover, the metal housing is a substantial portion of the weight of the electric motor. Each electric motor within a vehicle contributes to the overall weight of the vehicle. Automotive suppliers and manufactures continue to seek improvements to reduce cost, weight, increase efficiencies and simplify manufacture.

### SUMMARY

An electric motor according to an exemplary aspect of the present disclosure includes, among other things, an electrically and thermally conductive plastic housing defining an interior cavity and a plurality of magnetic plastic magnets supported within the interior cavity of the housing.

In a further non-limiting embodiment of the foregoing electric motor, the housing includes a plurality of radially extending ribs.

In a further non-limiting embodiment of any of the foregoing electric motors, the electrically conductive plastic housing includes 20% by weight ferritic stainless steel and polyphenylene sulfide plastic.

In a further non-limiting embodiment of any of the foregoing electric motors, the plurality of magnetic plastic magnets include 70% by weight Neodymium-iron-Boron powder and polyphenylene sulfide plastic.

In a further non-limiting embodiment of any of the foregoing electric motors, an end cover is attached to the housing and comprises the same electrically conductive plastic as the housing.

In a further non-limiting embodiment of any of the foregoing electric motors, the end cover is bonded to the housing with an electrically conductive adhesive.

In a further non-limiting embodiment of any of the foregoing electric motors, a bearing is press fit into the end cover and a shaft is supports a rotor relative to the magnets within the interior cavity.

In a further non-limiting embodiment of the foregoing electric motor, the electric motor is assembled into one of a window actuator and a seat actuator.

A process for fabricating an electric motor according to another exemplary aspect of the present disclosure includes, among other things, molding an electrically conductive plastic into a housing, molding a magnetic plastic material into a permanent magnetic within an interior cavity of the housing, and assembling the housing containing the molded permanent magnets into an electric motor assembly.

In a further non-limiting embodiment of the foregoing process for fabricating an electric motor, an end cover is molded from the same electrically conductive plastic used to mold the housing, a bearing is pressed into the molded end cover and the end cover is attached to the housing.

In a further non-limiting embodiment of any of the foregoing processes for fabricating an electric motor, the end cover is attached to the housing with an electrically conductive adhesive.

In a further non-limiting embodiment of any of the foregoing processes for fabricating an electric motor, one end of a shaft supports an armature and is assembled to the bearing to align the armature with the magnets supported within the housing.

In a further non-limiting embodiment of any of the foregoing processes for fabricating an electric motor, the electrically conductive plastic material includes 20% by weight ferritic stainless steel and polyphenylene sulfide plastic.

In a further non-limiting embodiment of any of the foregoing processes for fabricating an electric motor, the magnetic plastic material includes 70% by weight Neodymium-iron-Boron powder and polyphenylene sulfide plastic.

In a further non-limiting embodiment of any of the foregoing processes for fabricating an electric motor, the housing is molded to include a plurality of ribs extending outward from an outer surface of the housing.

In a further non-limiting embodiment of any of the foregoing processes for fabricating an electric motor, the housing is molded to include at least one mounting flange.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic view of a vehicle door including a window actuator having an example electric motor.

FIG. 2 is a schematic view of a vehicle seat including a seat actuator having an example electric motor.

FIG. 3 is a schematic view of an example window actuator including an example electric motor.

FIG. 4 is a schematic view of an example housing assembly for an electric motor.

FIG. 5 is a side view of the example housing assembly.

FIG. 6 is a side view of an example housing embodiment.

FIG. 7 is a cross-sectional view of the example housing.

FIG. 8 is a side view of an example end cover.

FIG. 9 is a front view of the example end cover.

FIG. 10 is a schematic representation of a process of forming and assembling components of an electric motor.

### DETAILED DESCRIPTION

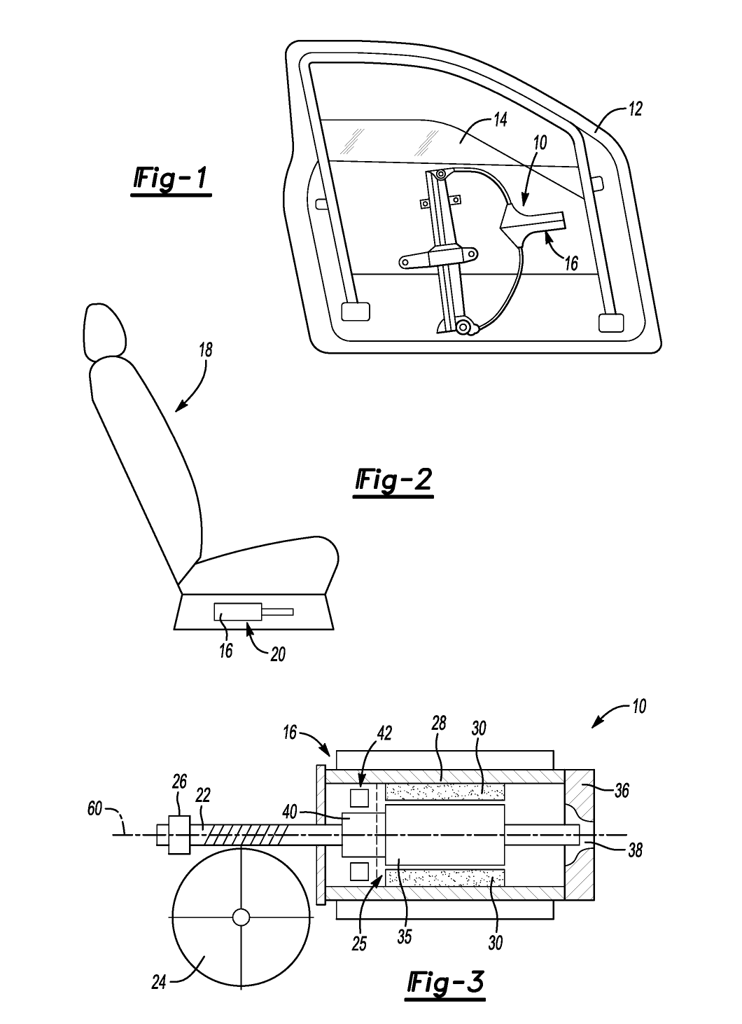

Referring to FIG. 1, an example vehicle door 12 includes a window 14 that is raised and lowered by an actuator 10. The actuator 10 utilizes an electric motor 16 to power movement of the window 14.

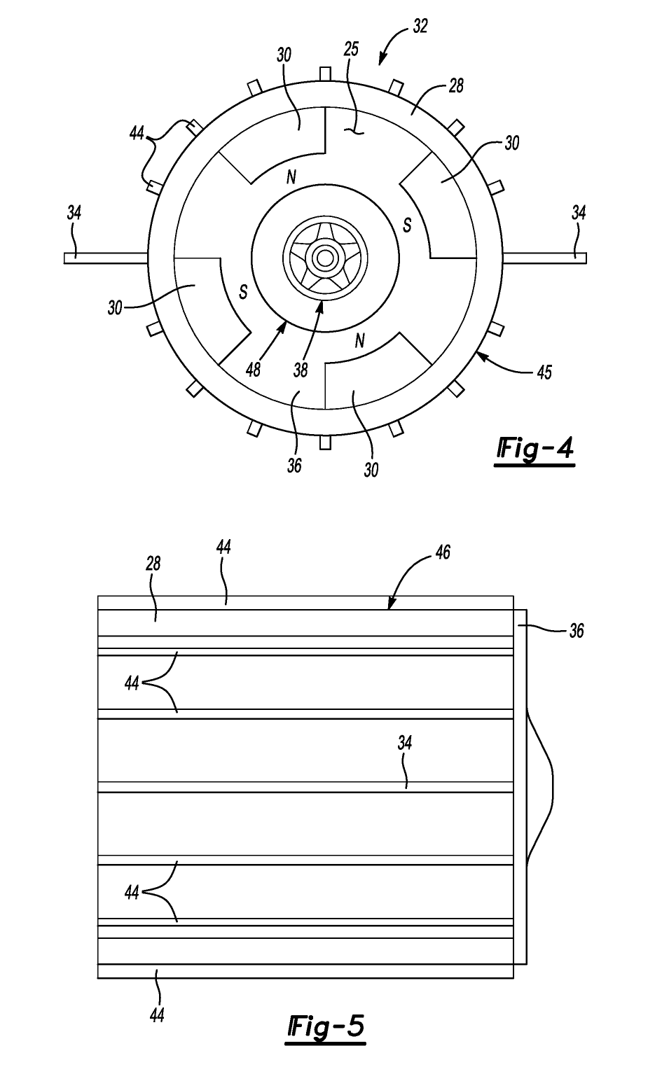

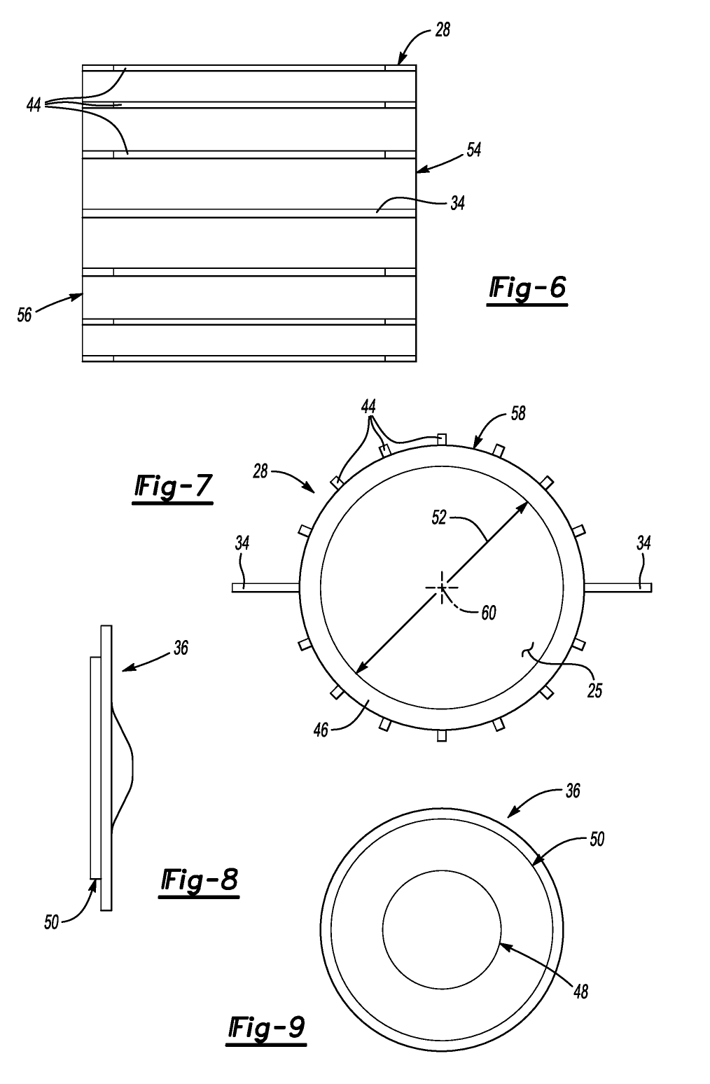

Referring to FIG. 2 with continued reference to FIG. 1, a seat 18 includes a seat actuator 20 that utilizes an electric motor 16. Electric motors 16 are part of various actuators utilized to adjust windows, mirrors, seats and any number of other adjustable devices and apparatus present within a motor vehicle.

Referring to FIG. 3, an example window actuator 10 is illustrated in cross-section and includes the electric motor 16 that drives a shaft 22 that in turn drives a reduction gear 24. The shaft 22 is supported at one end by bearing 38 and on a second end by bearing 26. It should be appreciated that the example actuator 10 is shown by way of example and other actuators having different drive configurations dependent on the specific use in the vehicle will also benefit from and are within the contemplation of this disclosure.

The example actuator 10 utilizes the electric motor 16 that includes a housing 28 supporting rotation of an armature 35 disposed about an axis 60. The armature 35 rotates relative to permanent magnets 30 secured within an interior cavity 25 of the housing 28. Commutator 40 provides an electrical connection with the armature 35 through brushes 42 as is known for a permanent magnet electric motor.

The electric motor 16 is a source of weight within a motor vehicle and is utilized in numerous locations. Therefore a reduction of weight within each of the electric motors can provide a significant overall weight reduction. The example housing 28 in one disclosed embodiment is formed from a light weight electrically and thermally conductive plastic material. The example housing 28 is molded from a lightweight plastic rather than stamped from a heavier metal material. The permanent magnets 30 are fabricated from a magnetic plastic material molded onto an interior surface of the housing 28.

Referring to FIGS. 4 and 5, an example housing assembly 32 includes a housing 28 defining an interior cavity 25 for integrally molded magnets 30 and an end cover 36. The housing assembly 32 is formed from a moldable plastic material that includes elements that provide for a desired level of electrical conductivity. The example housing 28 is electrically and thermally conductive to provide a low reluctance return path for magnetic flux and dissipate heat. In the disclosed example, the magnets 30 are permanent magnets molded from a plastic material including magnetically active materials.

The example housing 28 is formed with walls 46 that are significantly thinner and thereby weigh less than a housing formed entirely of metal. Because the walls 46 are significantly thinner than the metal counterpart, strengthening ribs 44 are provided on an outer surface 45 of the housing 28. The ribs 44 extend radially outward from the outer surface 45 of the housing 28 and provide a desired amount of rigidity. Moreover, the ribs 44 improve cooling characteristics by increasing the surface area of the outer surface 45 of the housing 28.

The example housing 28 also includes an integrally molded mounting flange 34 disposed on either side. It should be appreciated that although an example mounting flange 34 is shown, other configurations of mounting flanges that may be required to adapt to specific actuator configurations are within the contemplation of this invention.

An end cover 36 is attached to an end of the housing 28 and is formed from the same material used for the housing 28. The end cover 36 includes a cavity 48 for receiving a bearing 38 that supports one end of the shaft 22.

Referring to FIGS. 6 and 7, the housing 28 is molded from a ferritic, stainless steel reinforced plastic that provides low reluctance return path for the magnetic flux created by the permanent magnets 30. In one disclosed example, a blend of 20% by weight of ferritic stainless steel filled polyphenylene sulfide (PPS) plastic is molded into the shape of the housing 28. The PPS plastic is utilized as the base polymer since it has excellent heat deflection properties when filled with the ferritic stainless steel. The disclosed housing material provides a compound that is both thermally and electrically conductive and provides good electromagnetic field shielding capabilities.

In one disclosed example, the volume resistivity of the ferritic stainless steel reinforced plastic material is less than 1.0 ohm/cm³ to make the housing electrically conductive. The ferritic stainless steel is added as a metal powder and also provides thermal conductivity of around 2.7 W/mK. The increased thermal conductivity of the housing 28 further aids in maintaining favorable thermal properties of the electric motor 16.

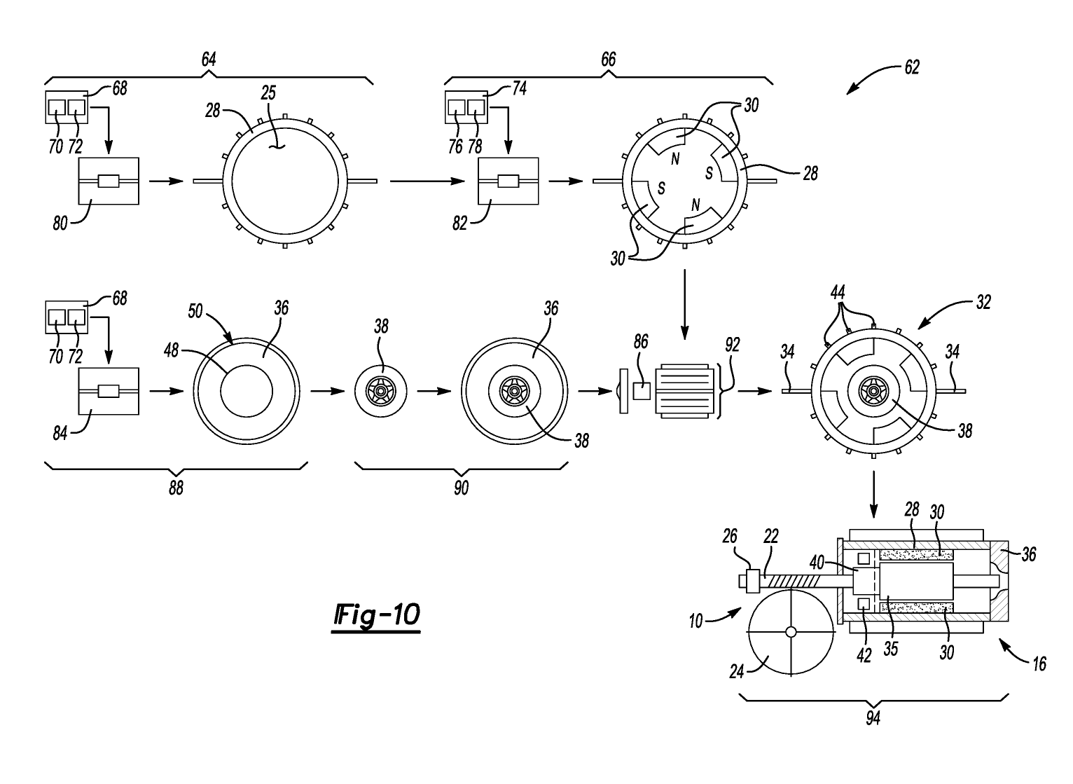

Referring to FIGS. 8 and 9, the end cover 36 is molded from the same material utilized to mold the housing 28 and includes a lip 50 that fits within inner diameter 52 of the housing 28. The end cover 36 also includes the cavity 48 that is defined to receive and hold the bearing 38. The bearing 38 supports the shaft 22 supporting the armature 35.

Referring to FIG. 10 with continued reference to FIGS. 7-9, an example process for creating the housing assembly 32, an electric motor 16 and actuator 10 is schematically illustrated. The process includes fabrication of the housing assembly 32 utilizing an initial two step molding process that includes a first shot 64 that forms the electrically conductive plastic housing 28 and a second shot 66 that molds the magnetic plastic permanent magnets 30 within the interior cavity 25 of the housing 28.

In the illustrated example, a mold 80 is utilized to define the interior and exterior surfaces of the housing 28. A first ferritic stainless steel filled plastic material 68 is injected into the mold 80 to form and define the shape of the housing 28. In this example, a conductive plastic material is formed with a first element 70 that comprises a polyphenylene sulfide (PPS) material. The first element 70 is mixed with an electrically active material. In this disclosed example, the electrically active material 72 is a ferritic stainless steel. The ferritic stainless steel 72 is added to the PPS material 70 in a powder form and provides the housing 28 with a desired level of electrical and thermal conductivity. Accordingly, in one disclosed example embodiment, the electrically conductive plastic material 68 for the housing 28 includes 20% by weight ferritic stainless steel 72 and PPS material 70. It should be appreciated that other formulations and electrically conductive plastic formulations could be utilized and are within the contemplation of this disclosure.

The completed housing 28 is then moved to a second mold 82 for the second shot injection molding process. Although a second mold 82 is schematically shown, the first shot 64 and the second shot 66 could also be performed as part of second process in a common mold or molding machine. The second shot injection molding process 66 utilizes a second material 74 that includes plastic material 76 and a magnetically active material 78. In this example, the plastic material 76 is the same PPS plastic material utilized to form the housing 28. The magnetic material 78 is a neodymium-iron-boron material that provides for creation of the permanent magnets 30. In a disclosed example embodiment the material 74 used to form the plurality of magnetic plastic magnets includes 70% by weight Neodymium-iron-Boron powder and PPS plastic material 76. It should be appreciated, that while an example formulation is disclosed by way of example, other magnetically active plastic material formulations could be used and are within the contemplation of this disclosure.

The inner cavity of the housing 28 provides at least a portion of the cavity or form for the magnets 30. Because the magnets 30 are molded directly into the housing 28, additional clips or other attachment features are not required. Accordingly, after the second shot 66, the housing 28 and magnets 30 comprise a substantially one piece part that is then combined with an end cover 36 to create the housing assembly 32.

The end cover 36 is formed in a process schematically indicated at 88 including a mold 84. The end cover is formed from material 68 that is the same as the material 68 utilized to form the housing 28. Maintaining a common material 68 between the end cover 36 and housing 28 provides consistent electrical and thermal properties in the completed housing assembly 32. In this example, the end cover 36 is formed to include cavity 48 configured to receive the bearing 38. The end cover 36 further includes an annular lip 50 that corresponds with an inner diameter 52 of the housing 28. The fit between the lip 50 and the inner diameter 52 aligns the bearing 38 within the housing 28 relative to the magnets 30.

After the end cover 36 is formed as schematically shown at 88, the bearing 38 is pressed into the bearing cavity 48 as indicated at 90. The end cover 36, including the bearing 38 is assembled to the housing 28. Attachment of the end cover 36 to the housing 28 is schematically illustrated at 92 and includes the use of an electrically conductive adhesive 86. The electrically conductive adhesive 86 forms an electrically conductive joint that holds the end cover 36 to the housing 28. The electrically conductive joint provided by the adhesive 86 provides a static conductivity between the end cover 36 and the housing 28. The static conductivity provides shielding to prevent electrostatic waves generated by the electric motor from interfering with other vehicle electronics. Moreover, the static conductivity provides a continuous low reluctance path for magnetic flux generated by the permanent magnets 30.

Once the end cover 36 is attached to the housing 28, the housing assembly 32 is complete and includes the end cover 36, integrally molded magnets 30 within the housing 28 and the bearing 38. The housing assembly 32 is then utilized to assembly the electric motor 16.

In this example, assembly of the motor components is schematically shown at 94 with regard to the window actuator 10 illustrated in FIG. 3 and includes the insertion of an end of the shaft 22 within the internal bearing 38, assembly of brushes 42 and commutator 40 within the housing assembly 32. In this example, the motor 16 is part of an actuator 10 that drives a reduction gear 24 that is utilized as a window actuator 10. It should also be appreciated that it is within the contemplation of this disclosure that the electric motor 16 including the disclosed housing assembly 32 may be utilized in other actuator applications including, for example, the seat actuator 20 shown in FIG. 2.

Accordingly, the example electric motor 16 is constructed utilizing a lightweight electrically conductive plastic housing 28 that includes a plurality of magnetic plastic magnets 30 using a two shot process that reduces motor weight, cost and improves assembly efficiencies.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An electric motor assembly comprising:
an electrically conductive plastic housing defining an interior cavity; and
a plurality of magnetic plastic magnets supported within the interior cavity of the housing.

2. The electric motor assembly as recited in claim 1, wherein the housing includes a plurality of radially extending ribs.

3. The electric motor assembly as recited in claim 1, wherein the electrically conductive plastic housing includes 20% by weight ferritic stainless steel and polyphenylene sulfide plastic.

4. The electric motor assembly as recited in claim 1, wherein the plurality of magnetic plastic magnets include 70% by weight Neodymium-iron-Boron powder and polyphenylene sulfide plastic.

5. The electric motor assembly as recited in claim 1, including an end cover attached to the housing, the end cover comprising the same electrically conductive plastic as the housing.

6. The electric motor assembly as recited in claim 5, wherein the end cover is bonded to the housing with an electrically conductive adhesive.

7. The electric motor assembly as recited in claim 5, including a bearing press fit into the end cover and a shaft supporting a rotor relative to the magnets within the interior cavity.

8. The electric motor assembly as recited in claim 1, wherein the electric motor is assembled into one of a window actuator and a seat actuator.

9. A process for fabricating an electric motor comprising the steps of:
molding an electrically conductive plastic into a housing;
molding a magnetic plastic material into a permanent magnetic within an interior cavity of the housing; and
assembling the housing containing the molded permanent magnets into an electric motor assembly.

10. The process as recited in claim 9, including molding an end cover from the same electrically conductive plastic used to mold the housing, pressing a bearing into the molded end cover and attaching the molded end cover to the housing.

11. The process as recited in claim 10, including attaching the end cover attached to the housing with an electrically conductive adhesive.

12. The process as recited in claim 10, including assembling one end of a shaft supporting an armature to the bearing to align the armature with the magnets supported within the housing.

13. The process as recited in claim 9, wherein the electrically conductive plastic material includes 20% by weight ferritic stainless steel and polyphenylene sulfide plastic.

14. The process as recited in claim 9, wherein the magnetic plastic material includes 70% by weight Neodymium-iron-Boron powder and polyphenylene sulfide plastic.

15. The process as recited in claim 9, including molding the housing to include a plurality of ribs extending outward from an outer surface of the housing.

16. The process as recited in claim 14, including molding the housing to include at least one mounting flange.
